(19) United States
(12) Patent Application Publication
(10) Pub. No.: US 2019/0136918 A1
(43) Pub. Date: May 9, 2019

(54) Ratchet Tooth Ring Torque Transfer Through Straight Spline Teeth

(71) Applicant: William B. Shook, Tampa, FL (US)

(72) Inventor: William B. Shook, Tampa, FL (US)

(21) Appl. No.: 16/027,539

(22) Filed: Jul. 5, 2018

Related U.S. Application Data
(60) Provisional application No. 62/604,653, filed on Jul. 14, 2017.

(51) Int. Cl. F16D 41/30; F16D 41/12; B60B 27/02; B60B 27/04

(52) U.S. Cl. CPC F16D 41/30; F16D 41/12; B60B 2900/111; B60B 27/047; B60B 27/023

(57) ABSTRACT

A ratchet tooth ring has ratchet teeth with a tooth root where a spline tooth is placed to prevent a thin spot in the ring at the tooth root. By using the same number of spline teeth on the periphery of the ratchet ring as the number of ratchet teeth and positioning the spline tooth opposite the ratchet tooth root the normal thin spot in the ring is avoided. The ratchet ring is mounted into a hub body and the spline teeth transfer torque from the ratchet ring to the hub body. The straight spline tooth on the periphery of the ring has a steep ramp angle to avoid multiplying the generated radial force exerted on the housing excessively when torque is applied. The ratchet teeth and the spline teeth can be forged at the same time making manufacturing lower cost.

### CROSS-REFERENCES TO RELATED APPLICATIONS

This application claims the benefit of U.S. Provisional Application No. 62/604,653 filed Jul. 14, 2017. The prior application is hereby incorporated by reference.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

The present invention relates generally to bicycle drive hubs with a ratchet and pawl, one-way clutch. More specifically, the invention relates to lightweight bicycle hubs in which the hub body may be made of a lighter, softer material than the ratchet ring and pawl material.

In conventional hubs of this design, the pawl transfers torque to the ratchet ring and the ring transfers torque to the hub body to transfer torque to the drive wheel. U.S. Pat. No. 6,155,394 to Shook is an example of the prior art, and is incorporated herein by reference. The current trend in hub design is to forge a ratchet ring that has ratchet teeth. The ring is threaded so that it may be screwed into the complementary thread on a hub body or a drive body. The applied drive torque during normal use of the bicycle tightens the ratchet ring into the hub body or drive body.

One problem with this design is that the thread on the ratchet ring must be very coarse and the hub, or drive, body must be fairly thick to prevent the thread from stripping when high torque is applied by a cyclist. Thickness in a hub or drive body is undesirable due to the higher priority of keeping the weight of a bicycle hub low and the strength high. However, when the ratchet ring is thin and the hub body, which is usually made of aluminum, is also thin, then the pressure generated by the thread expands the housing and the thread tips can strip. Also, when the housing expands, it no longer offers support to the ring and the pressure from the engaged pawl will bend the ring at the tooth root, which is the thin, and therefore weak, spot on the ring. Therefore, the need exists for a reduction in the weaknesses found in a conventional hub without increasing the weight substantially.

### BRIEF SUMMARY OF THE INVENTION

The present invention addresses the above-described problems by forming a ratchet ring that has a plurality of axial splines instead of threads, to inhibit relative rotation between the ratchet ring and the hub or drive body. The straight splines, with a small ramp angle, do not create axial force like a thread. Because the spline face angle is more like a buttress thread (with an angle of about 10 degrees, but which may be between 1 and 20 degrees) than a conventional 60 degree thread, the spline face does not create as much radial force for a given torque applied by the cyclist. In addition, the thin spot at each ratchet tooth root is reinforced by the spline tooth being positioned most strategically to strengthen the weakest portion of the ratchet ring. Preferably, the spline teeth are positioned just opposite, or across from, the ratchet teeth roots all around the ratchet ring.

### BRIEF DESCRIPTION OF THE SEVERAL VIEWS OF THE DRAWINGS

FIG. 1 is an end view illustrating an embodiment of a splined ratchet ring with inner ratchet teeth and outer spline teeth.

FIG. 2 is an end view illustrating a splined ratchet ring with outer ratchet teeth and inner spline teeth.

FIG. 3 is an end view illustrating an embodiment of an assembly of a ratchet ring having radially-inward ratchet teeth and radially-outward spline teeth, in combination with a pawl, a spring and carrier body and a hub body.

FIG. 4 is an exploded view in perspective illustrating a ratchet ring and a hub.

FIG. 5 is an end view illustrating an embodiment of an assembly of a ratchet ring having radially-outward ratchet teeth and radially-inward spline teeth in combination with a pawl, a spring, a carrier body and a hub body.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application No. 62/604,653 filed Jul. 14, 2017, which is the above claimed priority application, is incorporated in this application by reference.

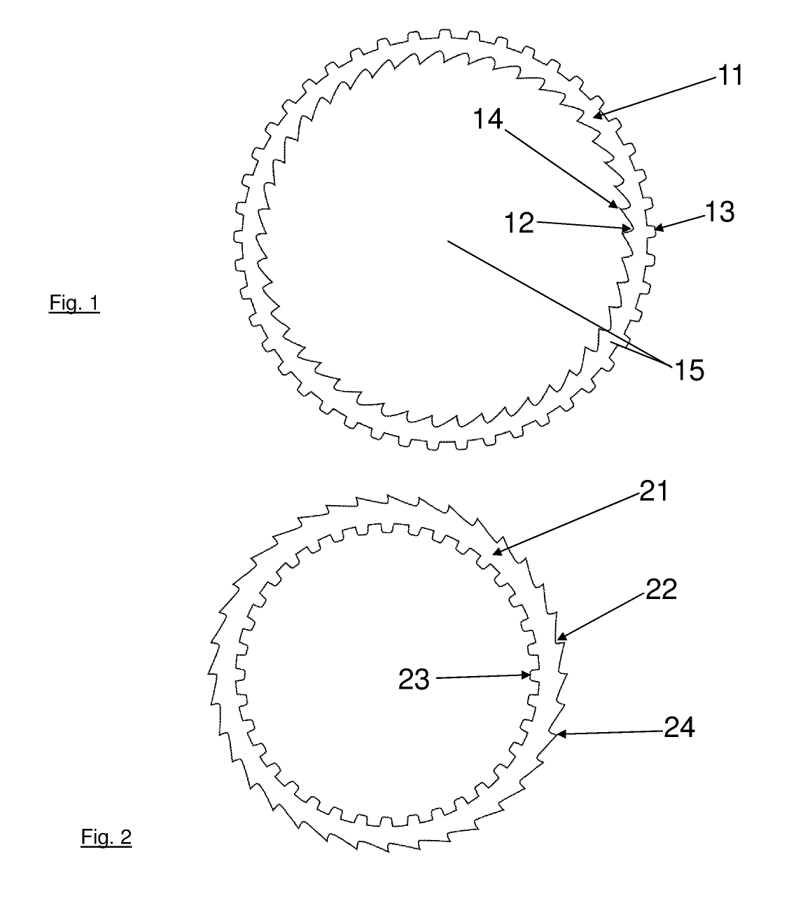

FIG. 1 shows a splined ratchet ring 11 with a plurality of radially-inwardly facing ratchet teeth, one example of which is the tooth 14, each of which has a corresponding ratchet tooth root 12 and a corresponding, radially-outwardly facing spline tooth 13. The root 12 is the lowest point between two next-adjacent ratchet teeth. The ratchet tooth 14, root 12 and spline tooth 13 are shown adjacent one another in FIG. 1, and there are a plurality of such corresponding adjacent ratchet teeth 14, tooth roots 12 and spline teeth 13 extending, equally spaced, around the ring 11.

Each of the spline teeth 13 is positioned on the ring 11 so as to reinforce the ring 11 where a corresponding ratchet tooth root 12 is formed. Each spline tooth 13 protrudes radially-outwardly from a peripheral edge of the ring 11 radially opposite the corresponding radially-inwardly facing ratchet tooth 14, and preferably spans across a circumferential surface of the ring 11 that is radially thinnest opposite a root 12.

Without the spline teeth 13, the ratchet tooth ring 11 would have thin spots at the ratchet tooth root 12, which would present a weakened point for the ring 11. In one embodiment, the spline teeth 13 extend about the circumferential length of the thinnest portion of the ring 11 to reinforce the ring 11 only at the root 12. In a preferred embodiment, each of the spline teeth 13 extend circumferentially beyond the thinnest portion of the ring 11 and along the portion of the ring 11 that is becoming thicker due to the presence of the adjacent ratchet teeth 14. In another embodiment, the spline teeth 13 extends circumferentially around the ring 11 beyond the thinnest ring portion to about 10 percent of the length of each next-adjacent ratchet teeth 14. In another embodiment, the spline teeth 13 extend circumferentially around the ring beyond the thinnest ring portion to about 20 percent of the length of each next-adjacent ratchet teeth 14

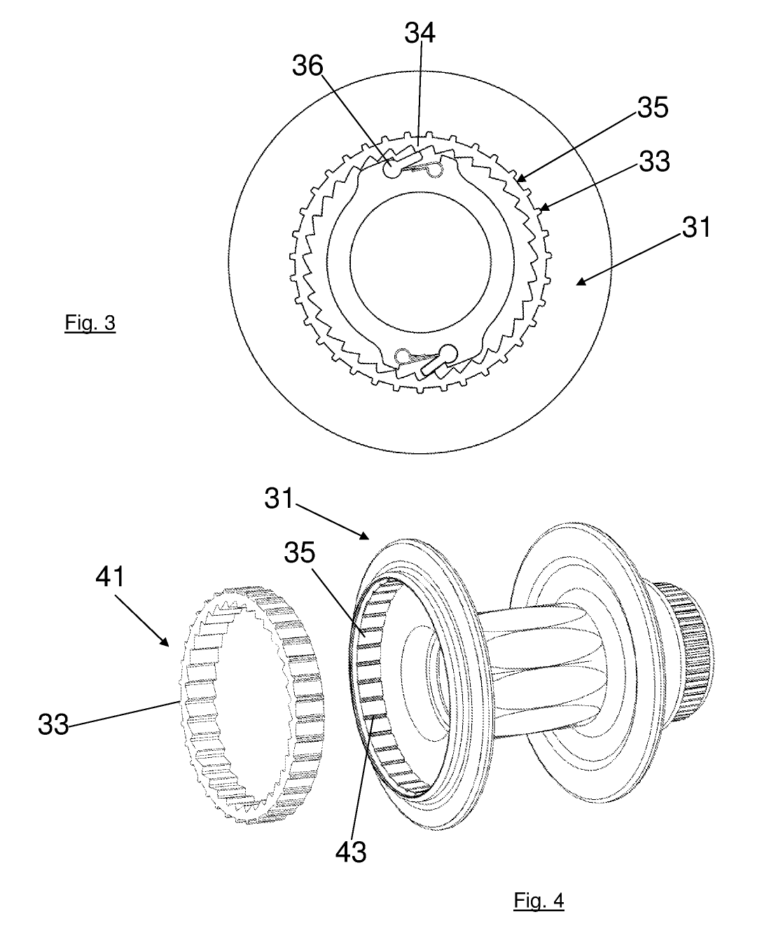

Each spline tooth 13 may have a radial thickness similar to the height of each ratchet tooth 14, which radial thickness is measured from the base of each spline tooth 13 to the most radially extreme point of the spline tooth 13. Each spline tooth 13 may be radially thinner or thicker than the ratchet teeth 14. Each spline tooth 13 has a face angle 15 (see FIG. 1) that is small compared to a conventional thread form that has a 60 degree included angle. This face angle may be between 1 and 20 degrees and is preferably about 10 degrees. This face angle 15 does not create as large a radial force for a given torque input as a conventional 30 or 60 degree thread form, but the angle 15 results in a low radial force being generated between the ring 11 and the hub or drive body 31 (see FIG. 3). Each spline tooth 13, which is preferably aligned parallel to the axis of the ring 11, creates no axial force on the hub or drive body 31 due to a torque input by the rider. The forces, both axial and radial for any given torque input on the aluminum housing 31 in FIG. 3, are lower than a ring with a conventional thread form.

Turning to FIGS. 3 and 4, the relative circumferential length of each spline tooth 33 on the ratchet ring 41 may be much smaller than the circumferential length of the mating tooth 35 of the mating body, such as the housing body 31, that extends radially into the ring 41. Since the mating body, the hub body 31 or the housing body, is made of softer but lighter material, the mating tooth 35 can be strengthened by being thicker (circumferentially longer). The pawl 36 is shown in a desired engagement in FIG. 3 with a ratchet tooth 34 of the ratchet ring 41.

Each of the axially aligned spline grooves 43 formed on the hub body 31 between the mating teeth 3 receives a corresponding spline tooth 33 of the ratchet ring 41 when the ratchet ring 41 is mounted in the hub body 31 as shown in FIG. 3. The spline grooves 43 are voids that are formed radially-outwardly in the hub body 31 and are a size sufficient to receive the spline teeth 33 with a friction fit so that during normal use the ratchet ring 41 will not move axially or circumferentially.

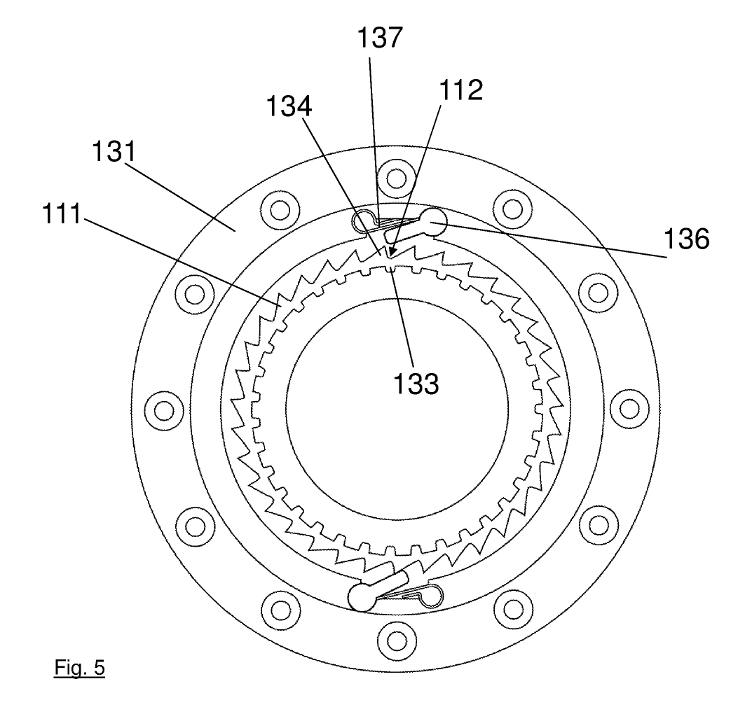

FIG. 2 shows an alternative structure that incorporates this same concept of reinforcing the ratchet tooth ring 21, but is radially reversed so that a radially-inwardly facing spline tooth 23 is positioned opposite a radially-outwardly facing ratchet tooth root 22. FIG. 5 shows a similar ratchet ring 111 in combination with a hub body 131, a pawl 136 (and corresponding spring 137). The spline tooth 133 faces radially inwardly to reinforce the ring 111 at the tooth root 112. Thus, the FIG. 2 and FIG. 5 embodiments are radially inverted compared to the FIG. 1 and FIG. 3 embodiments with the ratchet teeth 24 on the outside of the ring 21 facing outwardly. It is apparent that a person of ordinary skill will understand that the pawls, hub and other structures will have to be modified in position accordingly, and the person will know how to further modify the embodiments described herein to adapt the concept to different configurations.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A ratchet ring with ratchet teeth having tooth roots and having a straight axial spline positioned across the ring so as to reinforce each tooth root area.

2. The ratchet ring of claim 1 having spline teeth with a shallow face angle of about 1 degree to about 20 degrees.

3. The ratchet ring of claim 1 wherein the axial spline teeth are about one-half of the circumferential length of a plurality of mating teeth of a body into or onto which the ratchet ring will fit.

4. A hub body combined with a ratchet ring having a plurality of radially-inwardly facing ratchet teeth and tooth roots formed between each pair of next-adjacent ratchet teeth, the combination comprising:
(a) a plurality of substantially axially-aligned spline teeth extending radially-outwardly from a peripheral surface of the ratchet ring, each of said spline teeth aligned circumferentially with a corresponding tooth root;
(b) a plurality of substantially axially-aligned spline grooves extending radially-outwardly into the hub body to define mating teeth, wherein each of the spline teeth inserts into a corresponding one of the spline grooves.

5. The combination in accordance with claim 4, wherein the spline teeth have a face angle of about 1 degree to about 20 degrees.

6. The combination in accordance with claim 4 wherein the axial spline teeth are about one-half of the circumferential length of the mating teeth.

7. A hub body combined with a ratchet ring having a plurality of radially-outwardly facing ratchet teeth and tooth roots formed between each pair of next-adjacent ratchet teeth, the combination comprising:
(a) a plurality of substantially axially-aligned spline teeth extending radially-inwardly from a peripheral surface of the ratchet ring, each of said spline teeth aligned circumferentially with a corresponding tooth root;
(b) a plurality of substantially axially-aligned spline grooves extending radially-inwardly into a mating body to define mating teeth, wherein each of the spline teeth inserts into a corresponding one of the spline grooves.

8. The combination in accordance with claim 7, wherein the spline teeth have a face angle of about 1 degree to about 20 degrees.

9. The combination in accordance with claim 7 wherein the axial spline teeth are about one-half of the circumferential length of the mating teeth.

10. A ratchet ring comprising ratchet teeth having tooth roots, and a plurality of substantially axially-aligned spline teeth extending radially-outwardly from a peripheral surface of the ratchet ring, each of said spline teeth aligned circumferentially with a corresponding tooth root for reinforcing each tooth root area.

11. The ratchet ring in accordance with claim 10 further comprising spline teeth with a face angle of about 1 degree to about 20 degrees.

12. The ratchet ring in accordance with claim 10 wherein the axial spline teeth are about one-half of the circumferential length of a plurality of mating teeth of a housing into which the ring fits.
